(19) United States
(12) Patent Application Publication
(10) Pub. No.: US 2020/0302819 A1
(43) Pub. Date: Sep. 24, 2020

(54) GROUP ACTIVITY SUPPORT APPARATUS AND NON-TRANSITORY COMPUTER READABLE MEDIUM STORING PROGRAM

(71) Applicant: FUJI XEROX CO., LTD., Tokyo (JP)

(72) Inventors: Shinya NAKAMURA, Kanagawa (JP); Jun ANDO, Kanagawa (JP); Naoyuki ENOMOTO, Kanagawa (JP); Tadao MICHIMURA, Kanagawa (JP); Norio YAMAMOTO, Kanagawa (JP)

(73) Assignee: FUJI XEROX CO., LTD., Tokyo (JP)

(21) Appl. No.: 16/517,656

(22) Filed: Jul. 21, 2019

(30) Foreign Application Priority Data
Mar. 19, 2019 (JP) 2019-051187

(51) Int. Cl. G09B 7/00

(52) U.S. Cl. CPC G09B 7/00; G06F 3/0482

(57) ABSTRACT

A group activity support apparatus includes a setting section that acquires an attribute of each member in each group and sets characteristics of the group, and a presenting section that, in a case where an aim is assigned to plural groups, presents one or more discussion topics for each group based on the aim and the characteristics of the group.

### CROSS-REFERENCE TO RELATED APPLICATIONS

This application is based on and claims priority under 35 USC 119 from Japanese Patent Application No. 2019-051187 filed Mar. 19, 2019.

### BACKGROUND

### (i) Technical Field

The present invention relates to a group activity support apparatus and a non-transitory computer readable medium storing a program.

### (ii) Related Art

There is a learning method of dividing students into small groups, causing the theme to be discussed in each group, and collecting outputs in a group unit. Such a learning method is referred to as group learning. Group learning is a learning method that expects a mutual influence between members, and is expected to have a learning effect different from a learning effect of the lecture. In group learning, since the number of members of a group is small, it is expected that discussions among the members are facilitated, and consideration of the theme proceeds from various viewpoints.

An example of the related art includes WO2017/141338A.

### SUMMARY

However, a problem has been pointed out in that outputs of the discussion become similar to each other between the groups just by dividing the members participating in the discussion into plurality of groups and assigning a common theme. In other words, the output of each group does not contribute much to improvement of the output in the entire group.

Aspects of non-limiting embodiments of the present disclosure relate to provide a group activity support apparatus and a non-transitory computer readable medium storing a program for improving an output in the entire group in comparison to a method of assigning a common theme to groups.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a group activity support apparatus including a setting section that acquires an attribute of each member in each group and sets characteristics of the group, and a presenting section that, in a case where an aim is assigned to a plurality of groups, presents one or more discussion topics for each group based on the aim and the characteristics of the group.

### BRIEF DESCRIPTION OF THE DRAWINGS

Exemplary embodiment(s) of the present invention will be described in detail based on the following figures, wherein:

FIG. 1 is a diagram illustrating a conceptual configuration of an information processing system used in an exemplary embodiment;

FIG. 2 is a diagram illustrating a configuration example of a terminal of a teacher, a terminal of a student, a management server, and a group learning support apparatus;

FIG. 3 is a diagram illustrating an example of a functional configuration of a control unit constituting the group learning support apparatus used in the exemplary embodiment;

FIG. 4 is a flowchart illustrating a processing operation performed by the group learning support apparatus in the exemplary embodiment;

FIG. 5 is a diagram illustrating an example of a relationship between each group and members;

FIG. 6 is a diagram illustrating an example of information calculated as a result obtained by analyzing a submission;

FIG. 7 is a diagram illustrating an example of an operation screen displayed in a display of the terminal of the teacher;

FIG. 8 is a diagram illustrating an example of an operation screen used for presenting characteristics of a group;

FIG. 9 is a diagram illustrating an example of an operation screen used for inputting an aim of a class;

FIG. 10 is a diagram illustrating an example of an operation screen used for presenting candidates for a theme;

FIG. 11 is a diagram illustrating a state where the theme is selected for each group on the operation screen;

FIG. 12 is a diagram illustrating an example of an operation screen used for presenting candidates for a process;

FIG. 13 is a diagram illustrating a state where the process is selected on the operation screen;

FIG. 14 is a diagram illustrating an example of a display screen of the theme and the process of a discussion, which are presented to a student belonging to a group A;

FIG. 15 is a diagram illustrating an example of an operation screen used for the theme and an evaluation of the process; and

FIG. 16 is a diagram illustrating an example of data stored after group learning is performed.

### DETAILED DESCRIPTION

Hereinafter, exemplary embodiments of the present invention will be described with reference to the drawings.

### Exemplary Embodiment

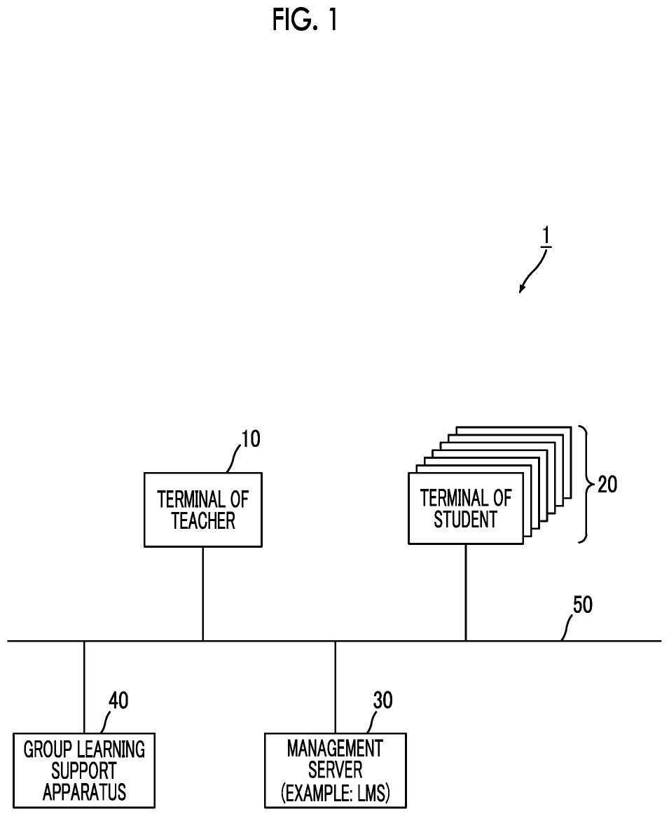

Overall Configuration of System FIG. 1 is a diagram illustrating a conceptual configuration of an information processing system 1 used in an exemplary embodiment. It is assumed that the information processing system 1 illustrated in FIG. 1 is used in an educational institution. Therefore, the information processing system 1 includes a terminal 10 operated by a teacher, a plurality of terminals 20 operated by students, a management server 30 that manages management data, and a group learning support apparatus 40 that supports group learning. Group learning is a form of a group activity.

In the exemplary embodiment, the terminal 10 may be referred to as the terminal 10 of a teacher, and the terminal 20 may be referred to as the terminal 20 of a student. In a case of FIG. 1, one terminal 10 of a teacher is provided. However, a plurality of terminals 10 of the teacher, which constitute the information processing system 1 may be provided. The terminal 10 of the teacher is an example of a terminal of a user who inputs an aim. All the terminal 10 of the teacher, the terminal 20 of the student, and the management server 30, and the group learning support apparatus 40 are connected to each other via a network 50. All the terminal 10 of the teacher and the terminal 20 of the student are computers capable of network connection. The computer may be a stationary computer or a portable computer. As the portable computer, for example, a notebook computer, a tablet computer, and a smartphone are assumed.

In the exemplary embodiment, the management server 30 is a server used, for example, in a learning management system (LMS), a teaching system, a book system, and the like. In a case where the management server 30 is provided in the LMS, the history of learning, outputs, records of attendance, records of submission of assignments, and the like are managed as management data. In a case where the management server 30 is provided in the teaching system, records of study, scores, grades, undergraduates, departments, majors, and the like are managed as the management data. In a case where the management server 30 is provided in the book system, records of lending, records of viewing, and the like are managed as the management data.

One management server 30 is not limited to the specific system described above. For example, one management server 30 may operate as a plurality of systems described above. Information stored in the management server 30 may be displayed in the terminal 10 of the teacher and the terminal 20 of the student. For example, the scores of the students, which are managed by the management server 30 may be displayed in the terminal 10 of the teacher, or the learning materials may be uploaded to the management server 30 from the terminal 10 of the teacher. The learning materials, and the score and the like of the student, which are managed by the management server 30 may be displayed in the terminal 20 of the student.

The group learning support apparatus 40 provides various services for supporting preparation of group learning in cooperation with the management server 30. For example, a function to extract characteristics of each group based on an attribute of a student constituting the group, a function to support determination of a theme to be assigned to each group so as to match with an aim input by the teacher, and the like are prepared in the group learning support apparatus 40. Here, the group learning support apparatus 40 is an example of a group activity support apparatus. As the network 50, for example, the Internet and a local area network (LAN) are provided. The network 50 may be wired or wireless.

Configuration of Apparatuses

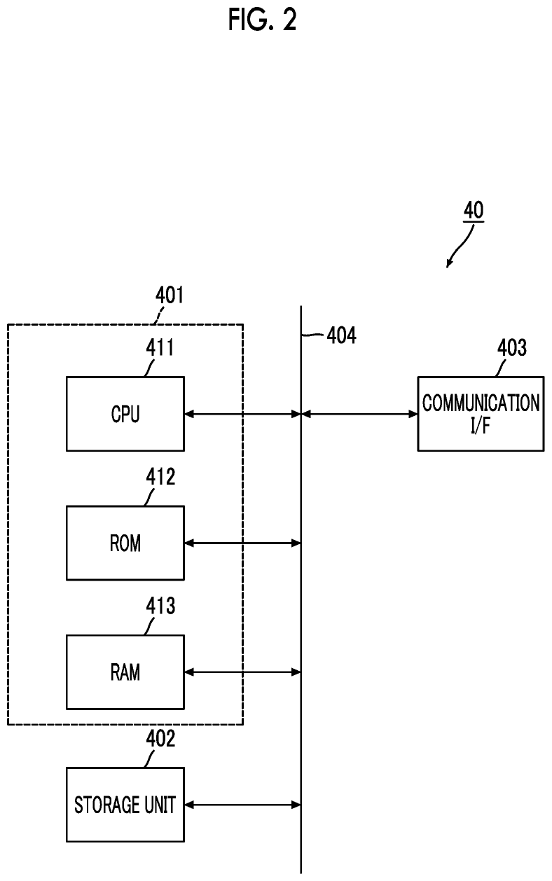

FIG. 2 is a diagram illustrating a configuration example of the terminal 10 (see FIG. 1) of a teacher, the terminal 20 (see FIG. 1) of a student, the management server 30 (see FIG. 1), and the group learning support apparatus 40. As described above, all the terminal 10 of the teacher, the terminal 20 of the student, the management server 30, and the group learning support apparatus 40 have a computer as a basic configuration. FIG. 2 illustrates the group learning support apparatus 40 as a representative example.

The group learning support apparatus 40 includes a control unit 401, a storage unit, and a communication interface (communication IF) 403. The control unit 401 controls an operation of the entirety of the apparatus. The storage unit 402 stores data, and the communication IF realizes communication through a LAN cable, for example. The control unit 401 includes a central processing unit (CPU) 411, a read only memory (ROM) 412 storing firmware, a basic input output system (BIOS), and the like, and a random access memory (RAM) 413 used as a work area. The CPU 411 may have a multi-core. The ROM 412 may be a rewritable non-volatile semiconductor memory.

The storage unit 402 is a non-volatile storage device and includes a hard disk drive (HDD) and a semiconductor memory, for example. The storage unit 402 stores data required to provide a service for supporting group learning. The control unit 401 is connected to the units through a bus 404 or a signal line (not illustrated). In the exemplary embodiment, the management server 30 may have the similar configuration to the configuration of the group learning support apparatus 40.

In the exemplary embodiment, a display unit used for displaying an operation screen and the like and an operation receiving unit that receives an operation of a user, as additional components, are provided in each of the terminal 10 of the teacher and the terminal 20 of the student. Here, the display unit includes a liquid crystal display and an organic EL display, for example. The display unit may be integrated with the main body of each of the terminals 10 and 20 or may be connected to the main body of each of the terminals 10 and 20 as an independent device. For example, a keyboard used for inputting characters and a mouse used for inputting movement of a point or selection on a screen are used as the operation receiving unit. In a case of the exemplary embodiment, an operation on the group learning support apparatus 40 is input with the display unit and the operation receiving unit of the terminal 10 of the teacher.

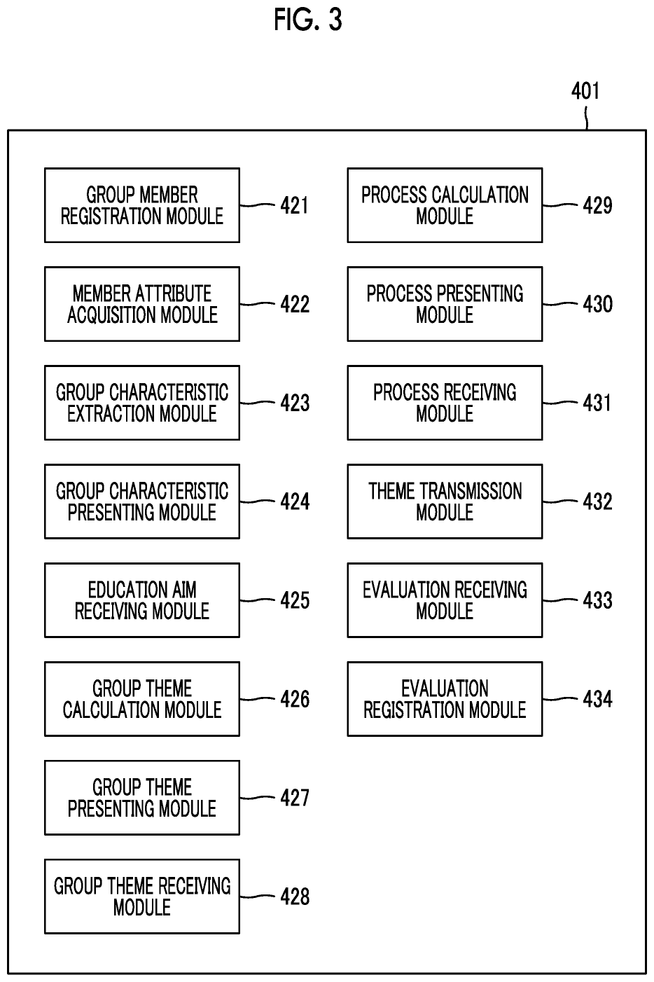

FIG. 3 is a diagram illustrating an example of a functional configuration of the control unit 401 constituting the group learning support apparatus 40 used in the exemplary embodiment. Functional modules illustrated in FIG. 3 are realized by the CPU 411 (see FIG. 2) executing a program. The modules illustrated in FIG. 3 are apart of the program executed by the control unit 401.

One of the functional modules illustrated in FIG. 3 is a group member registration module 421 that registers a member constituting a group. In the exemplary embodiment, four students constitute one group. The total number of groups is set to 10. That is, a case where the total number of students is 40 is assumed. The number of students constituting one group or the number of configured groups may have any value. An instruction of the name of the student constituting each group is received from the terminal 10 of the teacher, for example. As a method of performing an instruction of the name, a method in which the teacher inputs the name, a method in which the name is dragged and dropped, one by one, in a region of the corresponding group from a list of names, a method of reading a correspondence table between a group and students, which has been prepared in advance, and the like are provided. In a case where a data file in which a correspondence relationship between a group and members is recorded is provided, the group member registration module 421 may read information of the member corresponding to the group, from the data file.

One of the functional modules illustrated in FIG. 3 is a member attribute acquisition module 422 that individually acquires an attribute of a member constituting a group. In other words, the member attribute acquisition module 422 acquires the attribute of each student participating in group learning, from the management server 30 (see FIG. 1). As the attribute of the member, for example, information regarding the affiliation, information regarding scores, records regarding previous group learning, and information regarding a document (referred to as “a submission” below) submitted for an assignment are provided.

Among these kinds of information, the information regarding the affiliation includes, for example, the undergraduate and the department to which the student belongs, and the major. The records regarding the previous group learning includes, for example, characteristics of a group to which the student has belonged, the theme assigned to the group, a progress plan (also referred to as “a process”) used in learning, and an evaluation of outputs of the learning. The information regarding the submission includes, for example, a result and an evaluation obtained by analyzing the submission. The result obtained by analyzing the submission includes, for example, terms which are included in the submission and are highly relevant to the assignment assigned in advance and classifications indicating the contents that have been learned. In a case of the exemplary embodiment, the teacher evaluates the submission. In addition, an evaluation value obtained by calculation of software may be used.

One of the functional modules illustrated in FIG. 3 is a group characteristic extraction module 423 that extracts characteristics of a group. The characteristics of the group are extracted based on the attribute of a member constituting the group. For example, the group characteristic extraction module 423 extracts the characteristics of the group focusing on attributes held by many members. As such a method, a method of using an attribute value itself held by many members as the characteristics of the group, a method of using characteristics relating to a combination of attributes held by many members, as the characteristics of the group, and the like are provided.

For example, the group characteristic extraction module 423 extracts the characteristics of the group focusing on distribution of attributes integrated in each group. As such a method, a method of focusing on distribution of attributes held by many members, a method of focusing on distribution of attributes including an attribute held by only one member, and the like are provided. For example, the group characteristic extraction module 423 may determine the characteristics by using a model obtained by performing machine learning on a relationship in which attribute values of all members in a group are set as an input, and the characteristics of the group is set as an output. A relationship between attribute values of members constituting a group and characteristics of the group, which has been finally used, is given to learning of such a model, as teaching data.

In a case of the exemplary embodiment, the characteristics of a group are represented, for example, in terms of the knowledge of a member, contents learned in advance by the member, the quality of a submission. As the knowledge of a member, for example, “the knowledge of specific area is deep”, “the knowledge is broad but shallow”, and “the knowledge is uneven between members” are provided. Regarding the contents learned in advance by the member, for example, “many students have examined technical information”, and “attention points of everyday life are examined”, and “contents examined by the members are disjointed” are provided. Regarding the quality of a submission, for example, “good”, “normal, “not good”, and “variation is large” are provided. Here, the group characteristic extraction module 423 is an example of a setting section that sets the characteristics of a group. Here, “setting” means processing of correlating characteristics to a group. A method of determining the correlated characteristics or a method of extracting the characteristics is randomly used.

One of the functional modules illustrated in FIG. 3 is a group characteristic presenting module 424 that presents the extracted characteristics of the group. In a case of the exemplary embodiment, the characteristics of the group are presented to the teacher who prepares group learning. The characteristics of the group are presented to understand the correspondence relationship with the group. For example, the extracted characteristics of the group are displayed to be arranged along with a group name on the operation screen of the teacher. The presented characteristics of the group may be modified by the teacher.

One of the functional modules illustrated in FIG. 3 is a learning aim receiving module 425 that receives the aim of group learning. The aim of group learning is commonly used in all the plurality of groups. In other words, the aim of group learning is an aim in which all students participating in group learning are set as targets. Here, as the aim, for example, “I want to raise the whole”, “I want to dig deep”, and “I want to have an active discussion”.

One of the functional modules illustrated in FIG. 3 is a group theme calculation module 426 that calculates candidates for a theme of a discussion in accordance with the characteristics of each group. The group theme calculation module 426 calculates candidates for one or a plurality of themes, for one group. For example, a dedicated program which has been prepared in advance is used. Regarding calculation of candidates for a theme, for example, a method of reading a theme corresponding to a combination of an input aim of learning and the characteristics of a group, from a table in which themes are correlated with combinations of the aims of the learning and the characteristics of groups may be used. In addition, regarding the calculation of candidates for a theme, for example, a method of combining processing of determining the classification of an aim of learning and processing of determining the classification of the characteristics of a group and outputting a theme correlated with a combination of the results of the determinations may be used.

Further, for example, a model obtained by performing machine learning on a relationship in which an aim of learning and the characteristics of a group are set as an input, and candidates for a theme are set as an output may be used for the calculation of candidates for the theme. Such a model may be a model for each teacher or a model in which a plurality of teachers is set as targets. The model may be a model in which a school is set as a unit or a model in which a region is set as a unit. In the process of performing machine learning on the model, for example, a theme used for a combination between an aim used in group learning and characteristics of a group may be used as teaching data. In the process of performing machine learning on the model, an evaluation of a teacher for the used theme may be given to a Q value or a state action value, in addition to the relationship of the theme used for a combination of an aim used in group learning and characteristics of a group. In this case, machine learning proceeds such that priority is given to a relationship in which a high Q value is obtained.

One of the functional modules illustrated in FIG. 3 is a group theme presenting module 427 that presents the calculated candidates for a theme in correlation with a group. In a case of the exemplary embodiment, the candidates for a theme, which have been calculated for each group are presented to the teacher who prepares group learning. The candidates for a theme are presented to understand a correspondence relationship with the group. For example, the calculated candidates for a theme are displayed to be arranged along with a group name on the operation screen of the teacher. The number of the candidates for a theme is not limited to one, and a plurality of candidates may be provided. Here, the group theme presenting module 427 is an example of a presenting section.

One of the functional modules illustrated in FIG. 3 is a group theme receiving module 428 that receives a theme for each group. The group theme receiving module 428 receives a designation of a theme by the teacher who prepares group learning. In a case of the exemplary embodiment, the teacher selects any one, a plurality, or all of candidates for one or a plurality of themes presented for each group, on the screen. The group theme receiving module 428 receives the candidate selected by the teacher, as a theme to be used in group learning. In a case where there is no candidate desired to be selected, the teacher individually inputs a theme suitable for experiences of the teacher or a situation in the field. In a case where the teacher inputs the theme, the group theme receiving module 428 receives the input theme as a theme of the corresponding group.

One of the functional modules illustrated in FIG. 3 is a process calculation module 429 that calculates candidates for a process in which a plurality of groups is set as targets. It is considered that the output of the entire group varies depending on whether or not the selection of a process to be used is suitable for group learning. The candidates of a process include a plan in which an opportunity of announcing the output of a discussions in each group is provided at the end of class time, and a plan in which an opportunity of an interim announcement is provided. The candidates of a process include a plan in which an opportunity of the interim announcement is not provided, but an opportunity of exchange of contents under consideration, with contents of another group is provided. The process to be employed changes depending on a combination of characteristics of a group participating in a class. In the exemplary embodiment, candidates for a process which also uses an aim to be applied to the entirety of a plurality of groups are calculated. The process calculation module 429 calculates candidates for one or a plurality of themes. In this case, machine learning proceeds such that priority is given to a relationship in which a high Q value is obtained.

Regarding the calculation of the candidates for a process, for example, a method of reading a theme corresponding to a combination of an input aim of learning and the characteristics of a group, from a table in which processes are correlated with combinations of the classifications of the aims of the learning and the characteristics of groups may be used. In addition, regarding the calculation of the candidates for a process, for example, a method of combining processing of determining the classification of an aim of learning and processing of determining a combination of classifications of the characteristics of a group and outputting a process correlated with a combination of the results of the determinations may be used.

Further, for example, a model obtained by performing machine learning on a relationship in which an aim of learning and the characteristics of a plurality of groups are set as an input, and candidates for a process are set as an output may be used for the calculation of candidates for the process. Such a model may be a model for each teacher or a model in which a plurality of teachers is set as targets. The model may be a model in which a school is set as a unit or a model in which a region is set as a unit. In the process of performing machine learning on the model, for example, a process used for a combination between an aim used in group learning and characteristics of a group may be used as teaching data. In the process of performing machine learning on the model, an evaluation of a teacher for the used process may be given to a Q value or a state action value, in addition to the relationship of the process used for a combination of an aim used in group learning and characteristics of a group. In this case, machine learning proceeds such that priority is given to a relationship in which a high Q value is obtained.

One of the functional modules illustrated in FIG. 3 is a process presenting module 430 that presents the calculated candidates for a process. In a case of the exemplary embodiment, the candidates for a process, which have been calculated for the entirety of the plurality of groups are presented to the teacher who prepares group learning. The process may be displayed on a screen which is different from or the same as the screen on which the candidates for the theme are presented. The number of the candidates for a process is not limited to one, and a plurality of candidates may be provided. Here, the process presenting module 430 is an example of the presenting section.

One of the functional modules illustrated in FIG. 3 is a process receiving module 431 that receives a process to be used. The process receiving module 431 receives a designation of a process by the teacher who prepares group learning. In a case of the exemplary embodiment, the teacher selects any one, a plurality, or all of candidates for one or a plurality of processes presented on the screen, on this screen. The process receiving module 431 receives a candidate selected by the teacher as a process to be used in the class. In a case where there is no candidate desired to be selected, the teacher individually inputs a process suitable for experiences of the teacher or a situation in the field. In a case where the teacher inputs the process, the process receiving module 431 receives the input process.

One of the functional modules illustrated in FIG. 3 is a theme transmission module 432 that transmits the theme or the process to a student. The theme transmission module 432 transmits the theme corresponding to a group to which each student belongs, and the process relating to the group to which each student belongs.

One of the functional modules illustrated in FIG. 3 is an evaluation receiving module 433 that receives an evaluation for the output of learning. In a case of the exemplary embodiment, a screen on which the evaluation is input is presented to the teacher who prepares group learning. Here, as such an evaluation, an evaluation for an output of each group and an evaluation for a process are provided. In a case of the exemplary embodiment, an entry field of the evaluation for the output of each group is provided to be arranged with display of the theme used in the group. Since corresponding information is disposed to be arranged, it is possible to input an evaluation with confirming the theme. The entry field of the evaluation for the process is provided to be arranged with display of the used process. Since corresponding information is disposed to be arranged, it is possible to input an evaluation with confirming the process.

One of the functional modules illustrated in FIG. 3 is an evaluation registration module 434 that registers an evaluation associated with the theme used in group learning. In the exemplary embodiment, the evaluation registration module 434 records an attribute of each member constituting a group, characteristics of the group, a theme assigned to the group, an evaluation of a relationship between the theme and an output, a process used in the entire group, and an evaluation of a relationship between the process and the output, for each group. It is possible to use the accumulated records of evaluations in order to improve accuracy of candidates to be calculated.

Example of Processing Operation

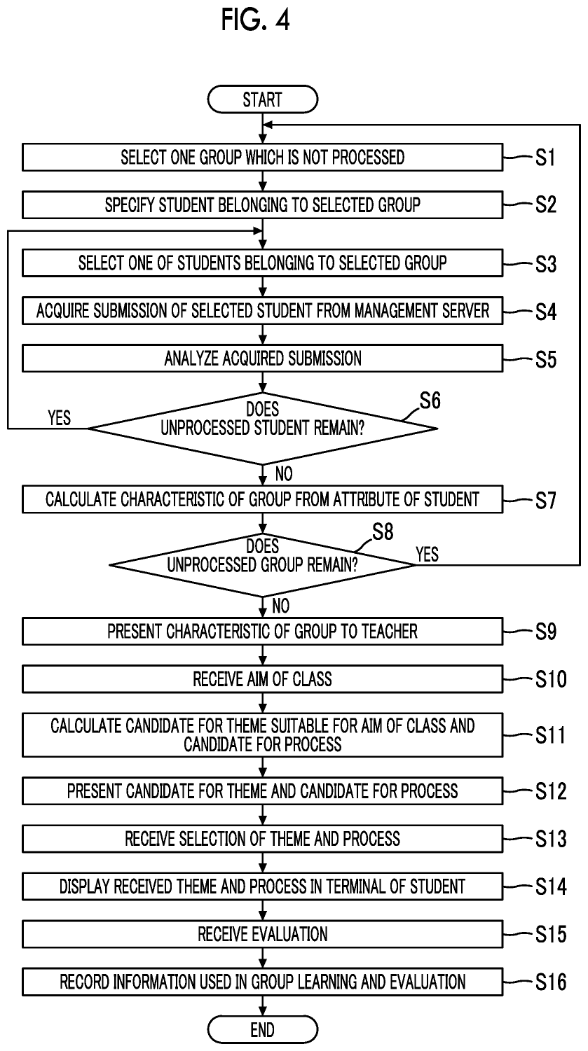

A processing operation in the exemplary embodiment will be described below. Here, it is assumed that four students constitute a group, and ten groups are provided. In the following descriptions, the ten groups are referred to as a group A, a group B, . . . , and a group J. FIG. 4 is a flowchart illustrating the processing operation performed by the group learning support apparatus 40 (see FIG. 1) in the exemplary embodiment. Firstly, the group learning support apparatus 40 selects one group which is not processed among the ten groups A to J (Step S1). Here, the group A is selected. The four students are already assigned to each group.

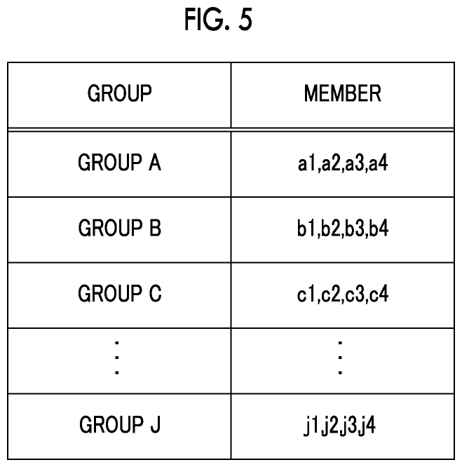

Then, the group learning support apparatus 40 specifies a student belonging to the selected group (Step S2). In the exemplary embodiment, the group learning support apparatus 40 specifies students a1, a2, a3, and a4 belonging to the group A. FIG. 5 is a diagram illustrating an example of a relationship between each group and members. In a case of the example in FIG. 5, members of the group A are the students a1, a2, a3, and a4, members of the group B are students b1, b2, b3, and b4, and members of the group C are students c1, c2, c3, and c4. Similarly, members of the group J are students j1, j2, j3, and j4. Descriptions return to FIG. 4. The group learning support apparatus 40 selects one of the students belonging to the selected group (Step S3). Here, one of the four students belonging to the group A is selected. For example, the student a1 is selected.

The group learning support apparatus 40 acquires a submission of the selected student from the management server (Step S4). The group learning support apparatus 40 may acquire another attribute of the selected student in addition to the submission. The group learning support apparatus 40 analyzes the acquired submission (Step S5). In a case of the exemplary embodiment, for example, information of specifying items learned by the student or the quality are calculated as a result of the analysis.

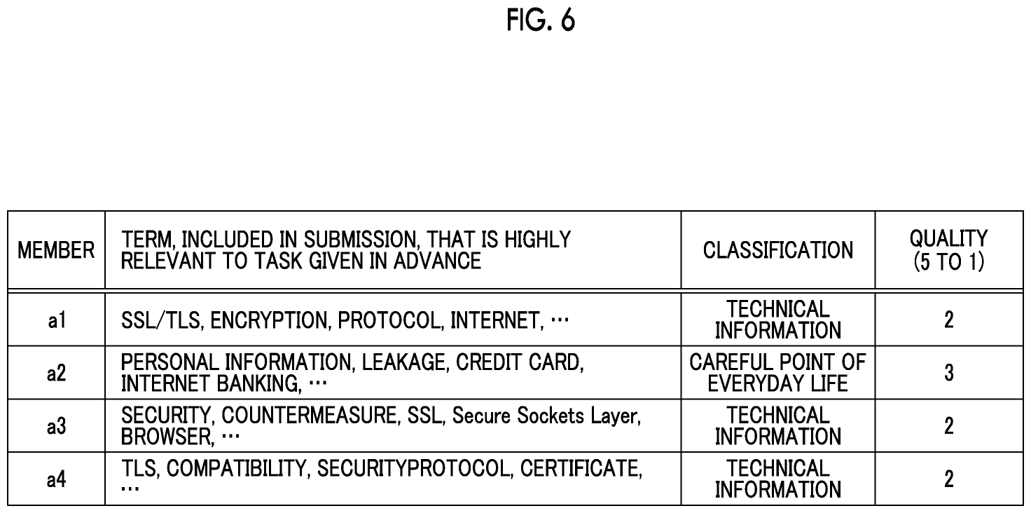

FIG. 6 is a diagram illustrating an example of information calculated as the result obtained by analyzing the submission. In FIG. 6, pieces of information calculated for the four students a1, a2, a3, and a4 constituting the group A are collected. In FIG. 6, as an example of the information of specifying the items learned by the student, “a term which is included in the submission and is highly relevant to the assignment assigned in advance” and “classification” are illustrated. The quality is given to five levels. In a case of FIG. 6, terms of “SSL (=Secure Sockets Layer)/TLS(=Transport Layer Security)”, “encryption”, “protocol”, “Internet”, and the like are included in the submission of the student a1. These terms are classified as “technical information”. As the quality, “2” is given to the submission of the student a1. In this example, “5” is the highest rank and “1” is the lowest rank. Thus, the quality of the submission of the student a1 is not good.

Descriptions return to FIG. 4. The group learning support apparatus 40 determines whether or not a not-processed student remains (Step S6). The group learning support apparatus 40 causes the process to return to Step S3 in a period in which a positive result is obtained in Step S6. In Step S3, one of not-processed students is selected. For example, the student a2 is selected by the group learning support apparatus 40. The processes of Steps S4 and S5 are performed for the student a2. In a case where processing for the student a2 ends, the processes of Steps S4 and S5 are repeated for the student a3 and the student a4. For the students a2, a3, and a4, information illustrated in FIG. 6 is calculated.

In a case where analysis of submissions of the four members constituting the group A ends, a negative result is obtained in Step S6. In a case where the negative result is obtained in Step S6, the group learning support apparatus 40 calculates characteristics of the group from the attributes of the students (Step S7). In a case of the exemplary embodiment, for example, “many students learn technical information”, “the quality is not so good” are calculated as the characteristics of the group A. Extraction of the characteristics focusing on an attribute other than the submission is also possible. In a case where the characteristics are calculated for the group being processed, the group learning support apparatus 40 determines whether or not a not-processed group remains (Step S8).

In the exemplary embodiment, in a case where a positive result is obtained in Step S8, the group learning support apparatus 40 causes the process to return to Step S1. The group learning support apparatus 40 causing the process to return to Step S1 selects one group from not-processed groups. For example, the group B is selected by the group learning support apparatus 40. In a case where the group B is selected, the characteristics of the group B are calculated based on attributes of the students b1, b2, b3, and b4. Similarly, the characteristics of the group C, the group D, . . . , and the group J are calculated. In a case where the characteristics of the last group J are calculated, a negative result is obtained in Step S8. In a case where the negative result is obtained in Step S8, the group learning support apparatus 40 presents the characteristics of each group to the teacher (Step S9).

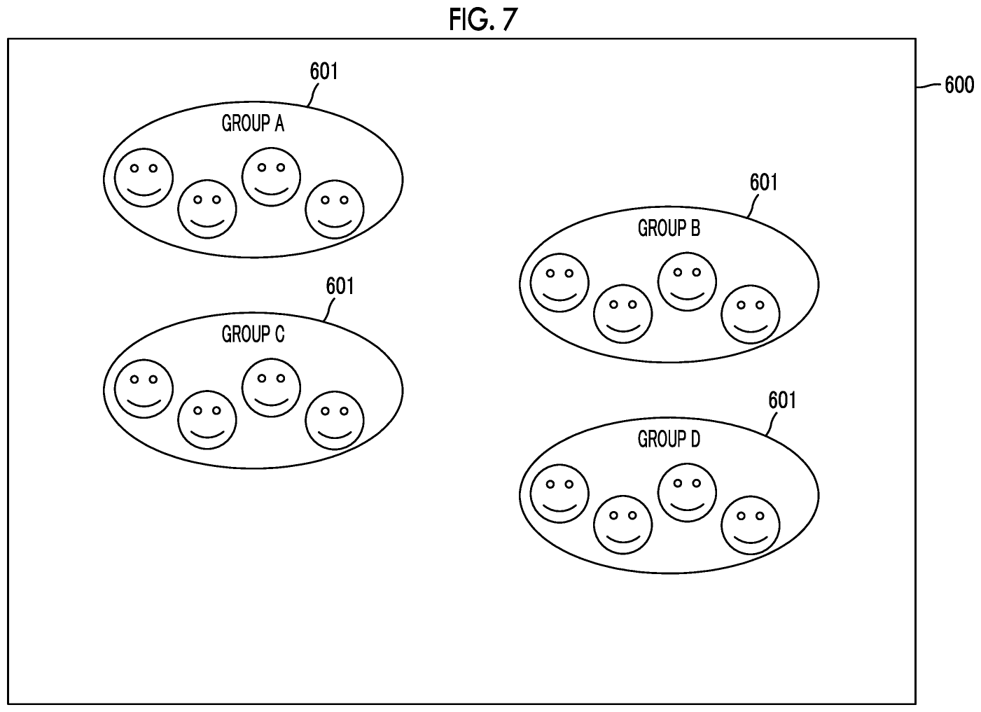

FIG. 7 is a diagram illustrating an example of an operation screen 600 displayed in the display of the terminal (see FIG. 1) of the teacher. The operation screen 600 illustrated in FIG. 7 depicts a state before the characteristics of each group are presented. In FIG. 7, only four groups among the ten groups are displayed. The name of the group and pictures of faces of the corresponding members are depicted in a FIG. 601 indicating the group. Indication of the member is not limited the picture of the face and may be the name, characters such as a student ID number, a face photo, and the like. The ten groups may be displayed on the operation screen 600.

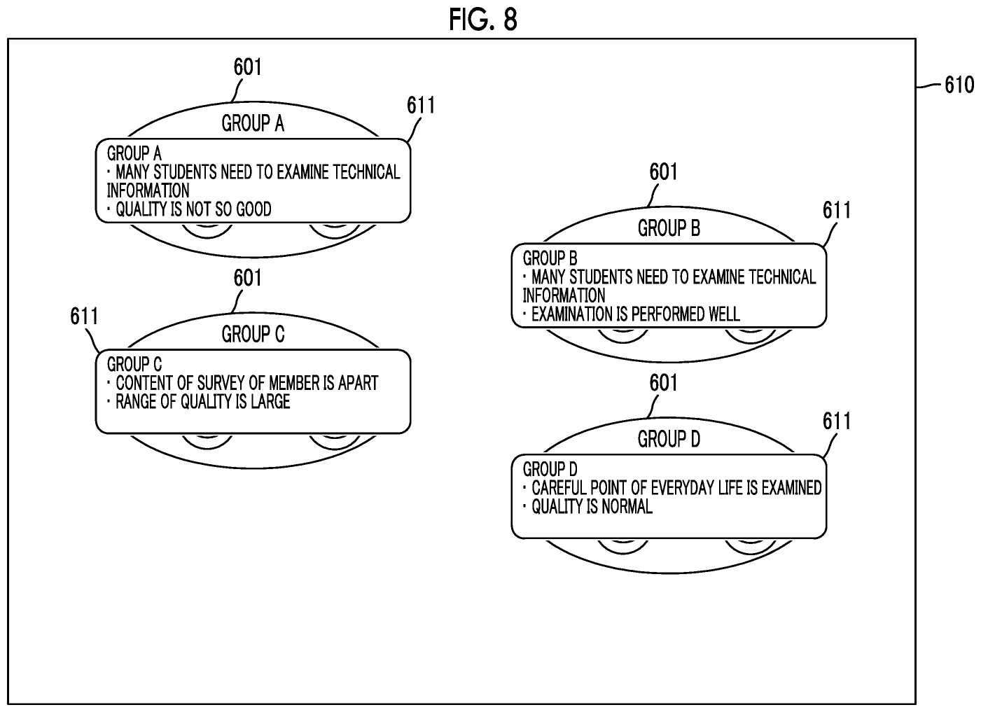

FIG. 8 is a diagram illustrating an example of an operation screen 610 used for presenting the characteristics of a group. In FIG. 8, components corresponding to those in FIG. 7 are illustrated with the corresponding reference signs. The operation screen 610 illustrated in FIG. 8 is also displayed in the terminal 10 (see FIG. 1) of the teacher. A display field 611 indicating the characteristics of each group is presented to overlap the FIG. 601 indicating the group, on the operation screen 610. For example, as the characteristics of the group A, two items of “many students need to examine technical information” and “the quality is not so good” are displayed. As the characteristics of the group B, two items of “many students need to examine technical information” and “examination is performed well” are displayed. As the characteristics of the group C, two items of “the contents of the survey of the members are apart” and “the range of the quality is large” are displayed. As the characteristics of the group D, two items of “careful points of everyday life are examined” and “quality is normal” are displayed.

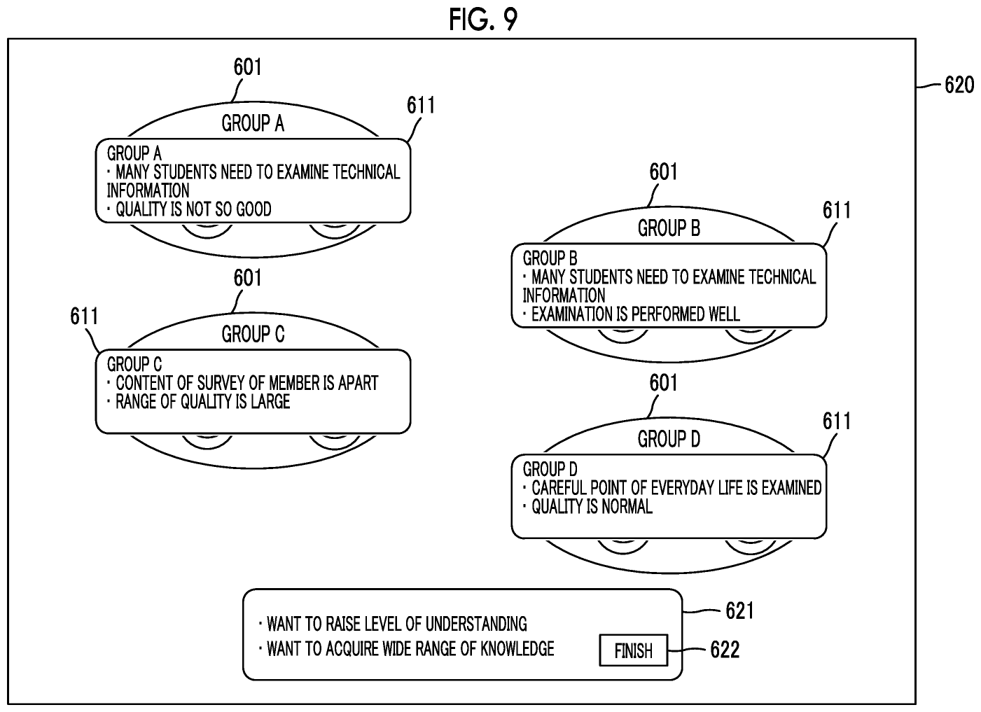

Descriptions return to FIG. 4. In a case where the characteristics of each group are displayed, an input field for inputting an aim of the class is displayed on the operation screen displayed in the display of the terminal 10 (see FIG. 1) of the teacher. FIG. 9 is a diagram illustrating an example of an operation screen 620 used for inputting the aim of the class. In FIG. 9, components corresponding to those in FIG. 8 are illustrated with the corresponding reference signs. The operation screen 620 illustrated in FIG. 9 is also displayed in the terminal 10 (see FIG. 1) of the teacher. An input field 621 used for inputting an aim of the class is added to the operation screen 620. In a case of FIG. 9, the teacher inputs two aims. Specifically, the two aims are “I want to raise the level of understanding and “I want to acquire a wide range of knowledge”. In a case where the teacher operates a determination button 622, a desired input is finished.

Descriptions return to FIG. 4. In a case where the group learning support apparatus 40 receives the aim of the class input by the teacher (Step S10), the group learning support apparatus 40 calculates candidates for a theme suitable for the aim of the class and candidates for a process (Step S11). As described above, the theme is calculated for each group, and the process is calculated by using the ten groups as targets. In a case where the candidates for the theme and the candidates for the process are calculated, the group learning support apparatus 40 presents the candidates for the theme and the candidates for the process to the display of the terminal 10 (see FIG. 1) of the teacher (Step S12). Then, the group learning support apparatus 40 receives selection of the theme and the process by the teacher (Step S13).

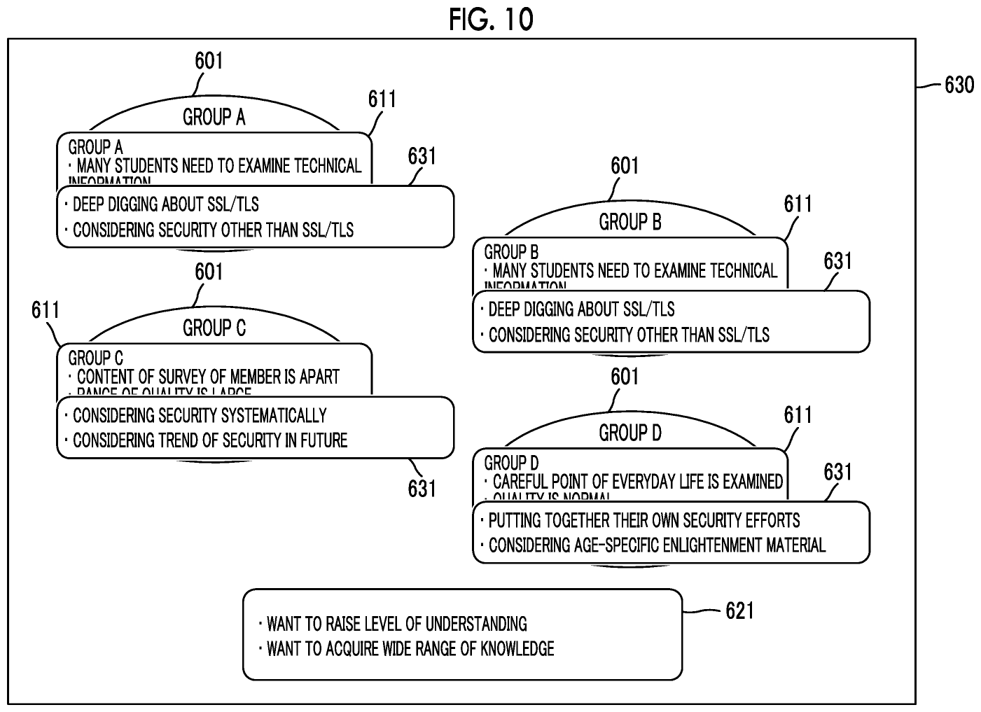

FIG. 10 is a diagram illustrating an example of an operation screen 630 used for presenting the candidates for the theme. In FIG. 10, components corresponding to those in FIG. 9 are illustrated with the corresponding reference signs. The operation screen 630 illustrated in FIG. 10 is also displayed in the terminal 10 (see FIG. 1) of the teacher. A display field 631 indicating the candidates for the theme, which are calculated for each group is displayed to overlap the FIG. 601 indicating the group and the display field 611 indicating the characteristics of the group, on the operation screen 630. In FIG. 10, some of the characteristics of each group are hidden by the display field 631. However, the characteristics of each group may be displayed not to be hidden.

Each display field 631 is movable on the screen. Thus, even in a case where some of the characteristics of each group are hidden by the display field 631, the position of the display field 631 is shifted on the screen, and thereby it is possible to recognize the contents of the presented theme while recognizing the characteristics of each group. The top two of the calculated candidates are displayed on the operation screen 630 illustrated in FIG. 10. For example, for the group A, two items of “deep digging about SSL/TLS” and “considering security other than SSL/TLS” are presented in the display field 631, as the candidates for the theme of the discussion. In a case where a scroll bar is embedded in the display field 631, the candidate for the theme displayed in the display field 631 may be switched by sliding the scroll bar.

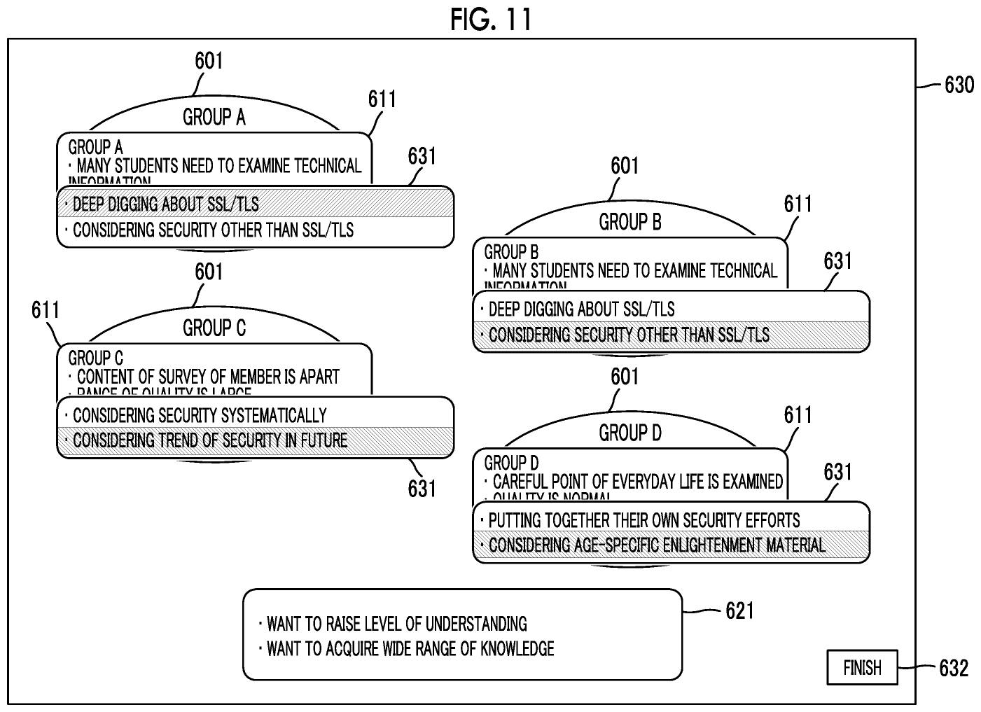

FIG. 11 is a diagram illustrating a state where the theme is selected for each group on the operation screen 630. In FIG. 11, components corresponding to those in FIG. 10 are illustrated with the corresponding reference signs. In FIG. 11, the theme selected by the teacher is displayed by hatching. For example, “deep digging about SSL/TLS” is selected for the group A. “Considering security other than SSL/TLS” is selected for the group B. “Considering a trend of security in future” is selected for the group C. “Considering age-specific enlightenment materials” is selected for the group D. In the example in FIG. 11, the themes of the discussions are selected not to overlap each other between the groups. In a case where the teacher operates a determination button 632, the selection of the theme is finished. In a case where a desired theme is not presented in the display field 631, the teacher may modify the contents of the theme. Here, the modification includes an input of a new theme.

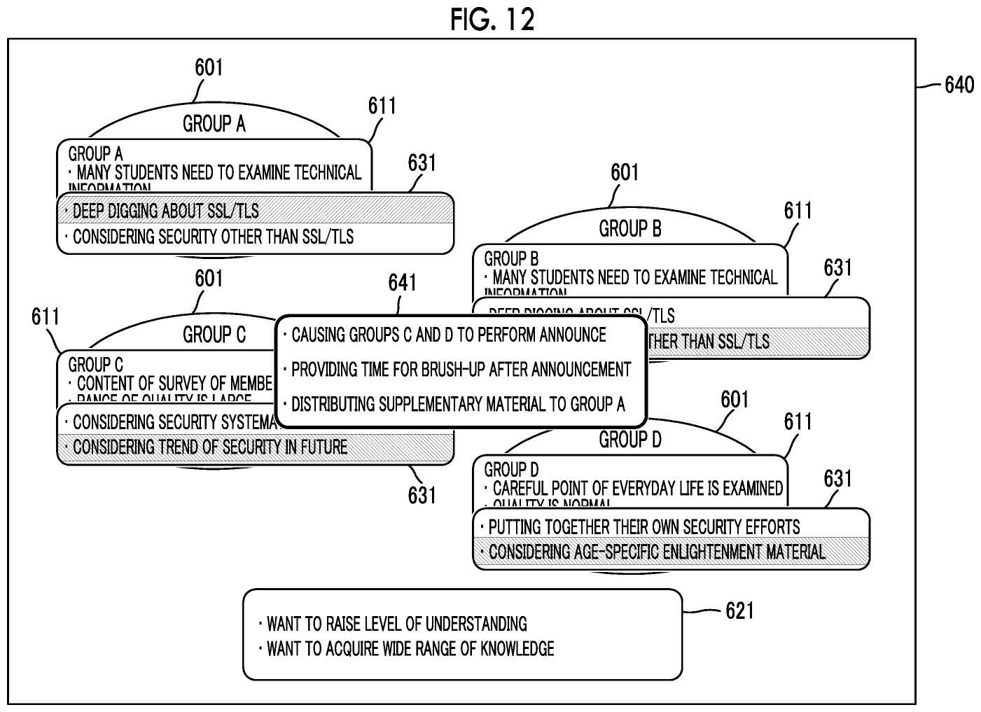

FIG. 12 is a diagram illustrating an example of an operation screen 640 used for presenting the candidates for the process. In FIG. 12, components corresponding to those in FIG. 10 are illustrated with the corresponding reference signs. The operation screen 640 illustrated in FIG. 12 is also displayed in the terminal 10 (see FIG. 1) of the teacher. A display field 641 indicating the candidates for the process, which are calculated for all the plurality of groups is displayed at the center of the operation screen 640. In a case of FIG. 12, the display field 641 is displayed to be located above other displays on the operation screen 640. In other words, the display field 641 is displayed to hide other displays.

The display field 641 is movable on the screen. Thus, even in a case where other displays are hidden by the display field 641, the position of the display field 641 is shifted on the screen, and thereby it is possible to recognize the contents of the process while recognizing the other displays. The display field 641 indicating the candidates for the process may be disposed not to overlap other displays on the operation screen 640. The top three of the calculated candidates are displayed on the operation screen 640 illustrated in FIG. 12. In the example in FIG. 12, three items of “causing the groups C and D to perform announce”, “providing time for brush-up after announcement”, and “distributing supplemental materials to the group A” are displayed in the display field 641, as the candidates for the process. In a case where a scroll bar is embedded in the display field 641, the candidate for the process displayed in the display field 641 may be switched by sliding the scroll bar.

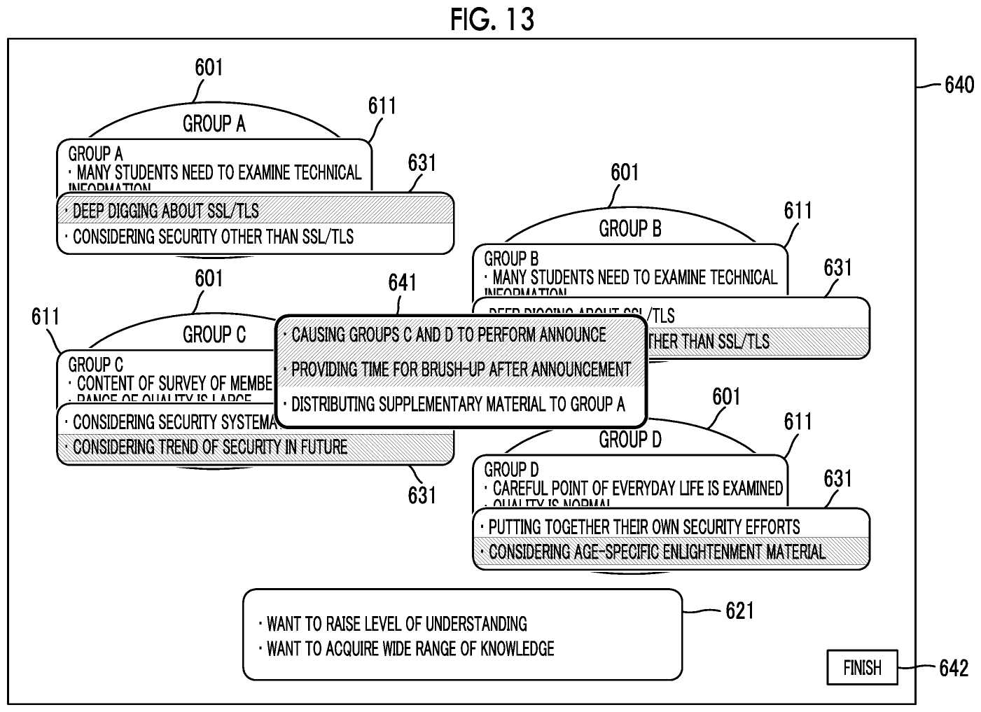

FIG. 13 is a diagram illustrating a state where the process is selected on the operation screen 640. In FIG. 13, components corresponding to those in FIG. 12 are illustrated with the corresponding reference signs. In FIG. 13, the process selected by the teacher is displayed by hatching. In the example, the two items of “causing the groups C and D to perform announce” and “providing time for brush-up after announcement” are selected. In a case where the teacher operates a determination button 642, the selection of the process is finished. In a case where a desired process is not presented in the display field 641, the teacher may modify the contents of the process.

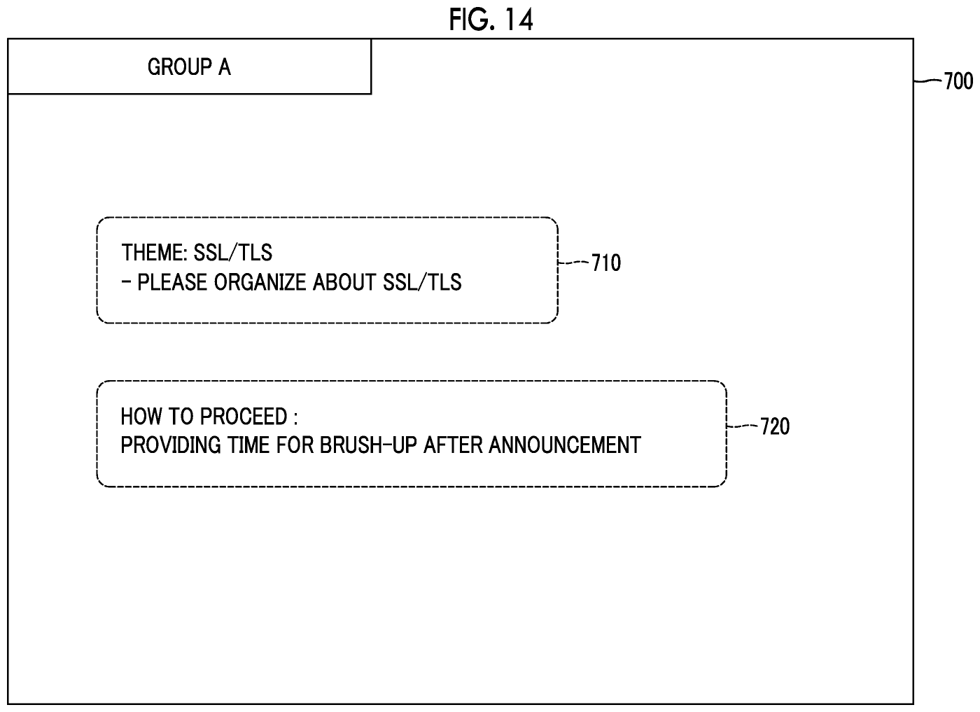

Descriptions return to FIG. 4. In a case where the teacher selects the theme and the process, the group learning support apparatus 40 displays the received theme and process in the terminal 20 (see FIG. 1) of the student (Step S14). The theme and the process to be displayed vary depending on the group to which the student belongs. For example, the theme selected for the group A and the process associated with the group A are displayed in the terminal 20 of the student belonging to the group A. FIG. 14 is a diagram illustrating an example of a display screen 700 of the theme of the discussion and the process, which are presented to the student belonging to the group A.

The theme selected for the group A by the teacher is “deep digging about SSL/TLS” as illustrated in FIG. 11. Therefore, “theme: SSL/TLS” and “please organize about SSL/TLS” are displayed in a display field 710 of the display screen 700. As the process selected for all groups by the teacher, two items of “causing the groups C and D to perform announce” and “providing time for brush-up after announcement” are selected as illustrated in FIG. 13. Among the items, the former plan does not have a relationship with the group A. Therefore, “providing time for brush-up after announcement” as a method of proceeding the discussion for the students belonging to group A is displayed in a display field 720 of the display screen 700.

Descriptions return to FIG. 4. With presenting the theme and the process described above, the student of each group obtains knowledge regarding the theme to be discussed by the student and the process of the class, before starting group learning. In addition, the theme assigned to each group is determined by reflecting the characteristics of the group. Therefore, improvement of quality of the discussion in the group is expected differing from a case where a plurality of groups discusses a shared theme. In the exemplary embodiment, the theme of each group is adjusted not to overlap those of other groups. Therefore, improvement of effects of learning of all students is expected by announcing the output obtained by the discussion. With presenting the contents of the process, the student may proceed discussions while foreseeing a method of proceeding the class.

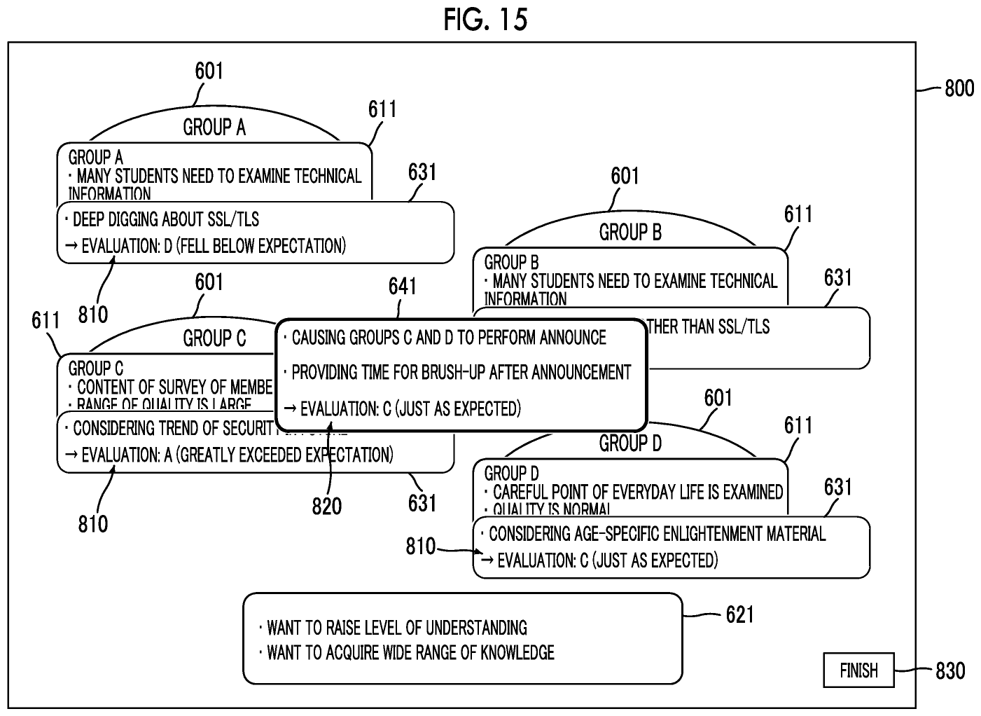

In a case where the announcement of each group and submitting of the outputs end, the teacher inputs evaluations on the theme used in the class and the process, with a dedicated screen. The group learning support apparatus 40 receives evaluations by the teacher (Step S15). FIG. 15 is a diagram illustrating an example of an operation screen 800 used for evaluating the theme and the process. In FIG. 15, components corresponding to those in FIG. 12 are illustrated with the corresponding reference signs. The operation screen 800 illustrated in FIG. 15 is also displayed in the terminal 10 (see FIG. 1) of the teacher. The operation screen 800 illustrated in FIG. 15 depicts a state where the evaluations of the teacher have been already input. In a case of the operation screen 800, the theme selected in FIG. 11 or input by the teacher and an evaluation 810 of the teacher on the output of learning of the corresponding group are indicated in the display field 631 corresponding to each group. The process selected in FIG. 13 or input by the teacher and an evaluation 820 of the teacher on the outputs of learning of the entire group are indicated in the display field 641 of the process of the class. Here, the display field 631 and the display field 641 are examples of the entry field of the evaluation.

In a case of the exemplary embodiment, the evaluation is given at four levels of A, B, C, and D. An A rank means “largely exceeding expectations”. A B rank means “exceeding expectations”. AC rank means “as expected”, and a D rank means “beyond expectations”. In a case of FIG. 15, the D rank as the evaluation 810 of the output on the theme is input for the group A. The C rank as the evaluation 820 of the output on the process is input. In a case where the teacher operates a determination button 830, the evaluation input on the operation screen 800 is determined.

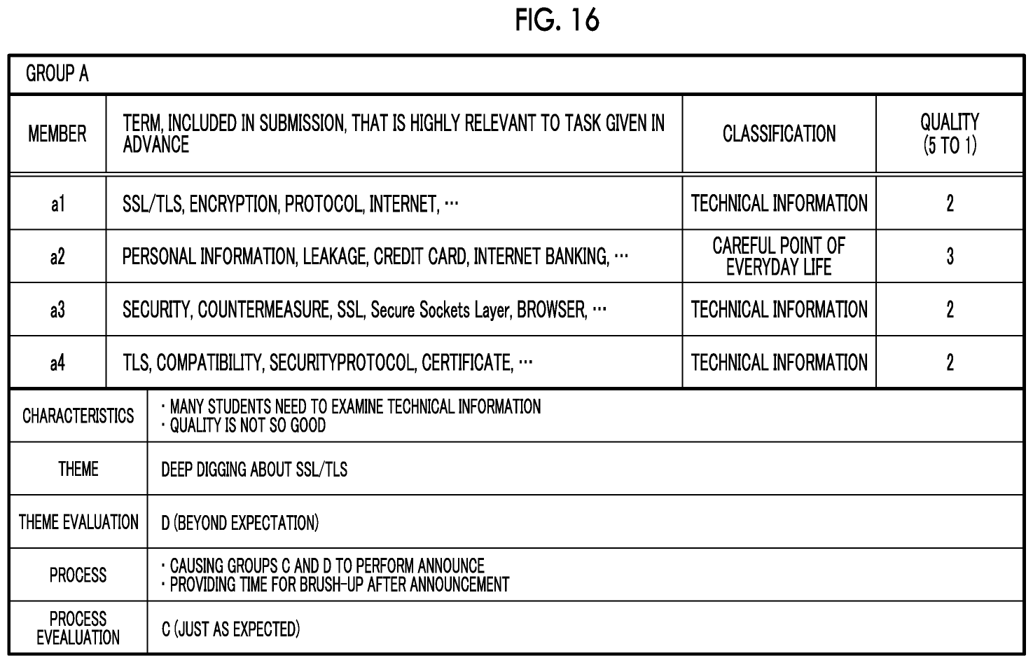

Descriptions return to FIG. 4. In a case where the operation of the determination button 830 is detected, the group learning support apparatus 40 records the information used in the group learning and the evaluation (Step S16). In a case of the exemplary embodiment, the information used in the group learning and the evaluation are recorded for each group. FIG. 16 is a diagram illustrating an example of data recorded after group learning is performed. The data illustrated in FIG. 16 is a record of the group A. In a case of FIG. 16, the information of the characteristics of the group A and the attribute used for extracting the characteristics of the group A, the theme assigned to the group A, the evaluation on the theme, the process applied to the entire group, and the evaluation on the process are recorded. Here, the data is stored in the storage unit 402 (see FIG. 2). The stored data is used for calculating candidates for a theme and for calculating candidates for a process in the next and subsequent times. The stored data is also used in machine learning of the model described above.

### OTHER EXEMPLARY EMBODIMENTS

Hitherto, the exemplary embodiment of the present invention is described. However, the technical scope of the present invention is not limited to the scope described in the above-described embodiment. It is apparent from the scope of the claims that various changes and improvements of the above-described embodiment are included in the technical scope of the present invention.

In the above-described exemplary embodiment, the function of the group learning support apparatus 40 (see FIG. 1) that supports preparation of group learning is described. However, the above-described function may be applied to a support of a group work employed in company training and interviews. The group work is a form of the group activity. An apparatus that supports the group work is an example of the group activity support apparatus. In a case of applying the group work, the member attribute acquisition module 422 (see FIG. 3) may acquire, for example, the department to which the member belongs, the operation for which the member is in charge, the previous operation experience, and the training history from a database managed in the company. In a case of applying the group work, the aim of an activity is input instead of the aim of learning.

In a case of the above-described exemplary embodiment, the group learning support apparatus 40 (see FIG. 1) is described as an apparatus independent from the management server 30 (see FIG. 1). However, the above-described function of the group learning support apparatus 40 may be performed as a portion of the function of the management server 30. The group learning support apparatus 40 may be realized as a cloud server or an on-premises server.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A group activity support apparatus comprising:
a setting section that acquires an attribute of each member in each group and sets characteristics of the group; and
a presenting section that, in a case where an aim is assigned to a plurality of groups, presents one or more discussion topics for each group based on the aim and the characteristics of the group.

2. The group activity support apparatus according to claim 1,
wherein the setting section displays the characteristics of each group in a terminal of a user inputting the aim.

3. The group activity support apparatus according to claim 2,
wherein the presenting section displays the one or more discussion topics for each group, in association with the characteristics of each group.

4. The group activity support apparatus according to claim 3,
wherein the one or more discussion topics are displayed to be selectable.

5. The group activity support apparatus according to claim 3,
wherein the presented one or more discussion topics theme are modifiable.

6. The group activity support apparatus according to claim 1,
wherein, after the theme for each group is determined, the presenting section presents one or more plans relating to a progress, which is to be applied to two or more of the plurality of groups.

7. The group activity support apparatus according to claim 6,
wherein the presenting section displays the one or more plans in proximity to h the theme determined for each group.

8. The group activity support apparatus according to claim 7,
wherein the candidates for the plan are displayed to be selectable.

9. The group activity support apparatus according to claim 7,
wherein the presented candidates for the plan are modifiable.

10. The group activity support apparatus according to claim 1,
wherein the theme used in the discussion and an entry field of an evaluation are displayed in association with each other, for each group.

11. The group activity support apparatus according to claim 10,
wherein a plan relating to a progress, which has been used in a group activity and the entry field of the evaluation are displayed in association with each other.

12. A non-transitory computer readable medium storing a program causing a computer to execute:
a function of acquiring an attribute of each member in each group and setting characteristics of the group; and
a function of, in a case where an aim is assigned to a plurality of groups, presenting one or more discussion topics for each group, based on the aim and the characteristics of the group.

13. A group activity support apparatus comprising:
setting means for acquiring an attribute of each member in each group and sets characteristics of the group; and
presenting means for, in a case where an aim is assigned to a plurality of groups, presenting one or more discussion topics for each group based on the aim and the characteristics of the group.
